(19) United States
(12) Patent Application Publication
(10) Pub. No.: US 2012/0050269 A1
(43) Pub. Date: Mar. 1, 2012

(54) INFORMATION DISPLAY DEVICE

(75) Inventor: Naoki AWAJI, Kawasaki (JP)

(73) Assignee: FUJITSU LIMITED, Kawasaki (JP)

(21) Appl. No.: 13/196,186

(22) Filed: Aug. 2, 2011

(30) Foreign Application Priority Data
Aug. 27, 2010 (JP) 2010-190410

(51) Int. Cl. G06T 15/00

(52) U.S. Cl. 345/419

(57) ABSTRACT

An information display device includes a storage area configured to store a display information item for displaying a real image on a display device; a focal length setting unit configured to set a second focal length that is different from a first focal length extending from a user to the real image displayed on the display device; a converting unit configured to convert the display information item stored in the storage area into a converted display information item for displaying a virtual image at the second focal length; and a virtual image displaying unit configured to display the virtual image at the second focal length based on the converted display information item.

### CROSS-REFERENCE TO RELATED APPLICATION

This patent application is based upon and claims the benefit of priority of the prior Japanese Patent Application No. 2010-190410 filed on Aug. 27, 2010, the entire contents of which are incorporated herein by reference.

### FIELD

The embodiments of the present invention discussed herein are related to an information display device for displaying information on a display device.

### BACKGROUND

In recent years, technologies of displaying images have advanced. Accordingly, technologies for displaying three-dimensional still images and video images have been developed, and the quality of displayed three-dimensional videos has improved.

For example, there is a method of disposing light beam control elements so that light beams are directed toward the viewer. Specifically, light beams from a display panel are immediately controlled before the display panel in which the pixel positions are fixed, such as a direct-view-type or a projection-type liquid crystal display device or a plasma display device. There is proposed a mechanism for controlling variations in the quality of the displayed three-dimensional video images, with a simple structure. Such variations are caused by variations in the gaps between the light beam control elements and the image display part.

Japanese Laid-Open Patent Publication No. 2010-078883

The conventional three-dimensional display technology is a high-level technology developed for viewing videos that appear to be realistic. The conventional three-dimensional display technology is not intended to be used in personal computers that are operated by regular people in their daily lives.

Modern people spend most of their days viewing screen images displayed in personal computers, and repeatedly operating the personal computers by entering information according to need. Accordingly, physical load due to eye fatigue has been a problem. Specifically, (1) the eyes fatigue when the eyes are located close to a display device for a long period of time. Furthermore, (2) the length between the eyes and the display device is fixed during operations, and therefore the focus adjustment function of eyes is also fixed for a long period of time without changing. This leads to problems such as short-sightedness.

### SUMMARY

According to an aspect of the present invention, an information display device includes a storage area configured to store a display information item for displaying a real image on a display device; a focal length setting unit configured to set a second focal length that is different from a first focal length extending from a user to the real image displayed on the display device; a converting unit configured to convert the display information item stored in the storage area into a converted display information item for displaying a virtual image at the second focal length; and a virtual image displaying unit configured to display the virtual image at the second focal length based on the converted display information item.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is for describing the relationship between a convergence angle and a length when information is regularly displayed;

FIG. 2 three-dimensionally illustrates the relationship between display information that is regularly displayed and the positions of the user's eyes;

FIG. 3 illustrates a modification of a focal position where the length between the user and the display information is extended;

FIG. 4 illustrates a modification of the focal position where the length between the user and the display information is reduced;

FIG. 5 is a block diagram of a hardware configuration of a computer device;

FIG. 6 is a functional block diagram of the computer device;

FIG. 7 is a flowchart for describing a process according to the present embodiment;

FIG. 8 illustrates an example where depth is applied to two-dimensional display information in the extended direction;

FIG. 9 illustrates a display example of plural sets of two-dimensional display information;

FIG. 10 is a display example in which a focal length is changed within a single virtual image;

FIG. 11 illustrates positions of position sensors;

FIG. 12 illustrates an example of an effect part for giving a more natural sense of distance;

FIG. 13 illustrates an example of a regular display of a two-dimensional real image;

FIG. 14 illustrates an example of a display in which depth is applied to the two-dimensional real image;

FIG. 15 illustrates another example of a two-dimensional real image that is regularly displayed;

FIG. 16 illustrates another display example in which depth is applied to a two-dimensional real image;

FIG. 17 illustrates a display example of display information inside a processed window;

FIG. 18 illustrates an example of a data configuration of a storage area for storing three-dimensional display information;

FIG. 19 is a flowchart for describing a method of enlarging or reducing and applying depth to a three-dimensional image

FIG. 20 describes an example of a regular display of a three-dimensional image;

FIG. 21 displays a display example of a three-dimensional image with depth;

FIG. 22 illustrates a regular display example in which a two-dimensional real image and a three-dimensional image are mixed; and

FIG. 23 illustrates a display example where depth is applied to the three-dimensional image of FIG. 22.

### DESCRIPTION OF EMBODIMENTS

Preferred embodiments of the present invention will be explained with reference to accompanying drawings. An embodiment of the present invention has been made based on the following technology. Specifically, the focal length between the user's eyes and a three-dimensional display image changes according to the focal position of the viewer. Therefore, eye fatigue may be mitigated and the eyesight may improve, compared to the case of viewing display information displayed at a fixed position over a long period of time. Thus, the inventor of the present invention focused on the assessment that eye fatigue may be mitigated by changing the focal length between the user and the display information, by causing a general-purpose computer such as a personal computer placed on a desk to display two-dimensional display information in a three-dimensional manner.

A description is given of the length that is recognized based on the convergence angle of the left and right eyes of a user, when two-dimensional display information is displayed in a regular manner on a display device of a personal computer without changing the focal length (hereinafter, “regularly displayed”).

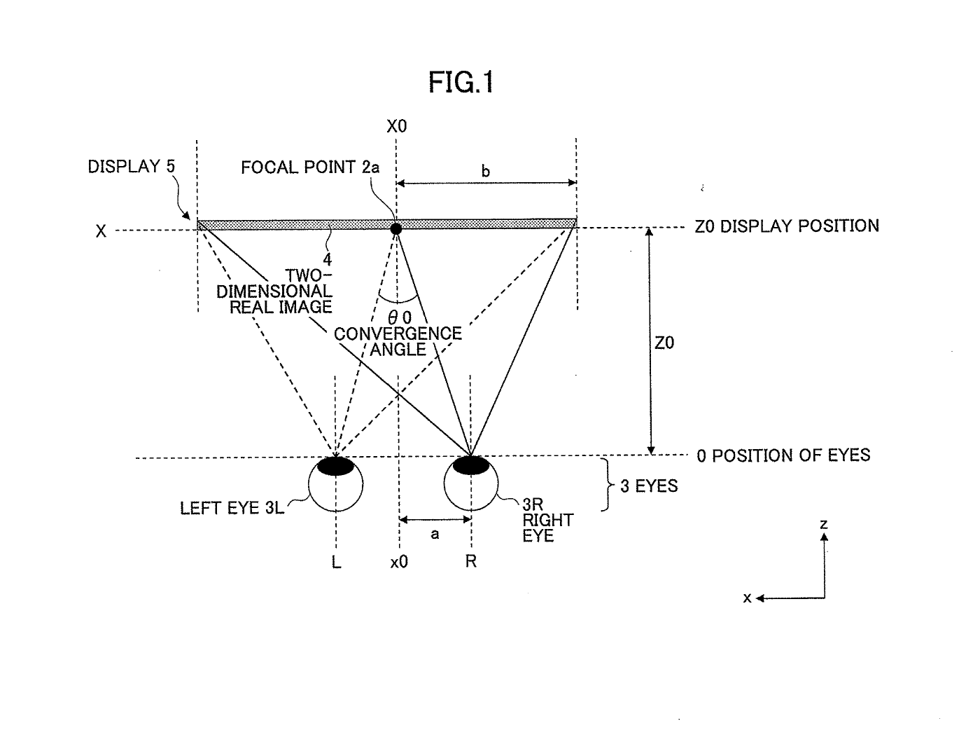

FIG. 1 is for describing the relationship between the convergence angle and the length when information is regularly displayed. In FIG. 1, the positions of eyes 3 are assumed to be origins, horizontal positions are expressed along an x axis, and the positions along the length between the eyes 3 and a display 5 are expressed along a z axis. A y axis corresponds to the vertical direction. The same applies to the subsequent figures.

In FIG. 1, when the user views, from a position “0” of the eyes 3, a two-dimensional real image 4 displayed on the display 5 disposed at a display position “Z0” in the z axis direction, the convergence angle is θ0 at a focal point 2a with respect to the two-dimensional real image 4, according to the difference between the positions of a left eye 3L and a right eye 3R of the user along the x axis. Accordingly, the user's brain recognizes the length between his eyes 3 and the two-dimensional real image 4. Specifically, the user recognizes a value “Z0” (=display position).

FIG. 1 illustrates a focal point 2a that is the center of a display screen image at the display position Z0, and the position of the focal point 2a along the x axis expressed by X0. A width a extends between the position x0 in the x axis direction corresponding to the focal point 2a (i.e., the center point between the left eye 3L and the right eye 3R) and the right eye 3R. A width b extends between the edge of the display screen image and the focal point 2a at the center of the display screen image.

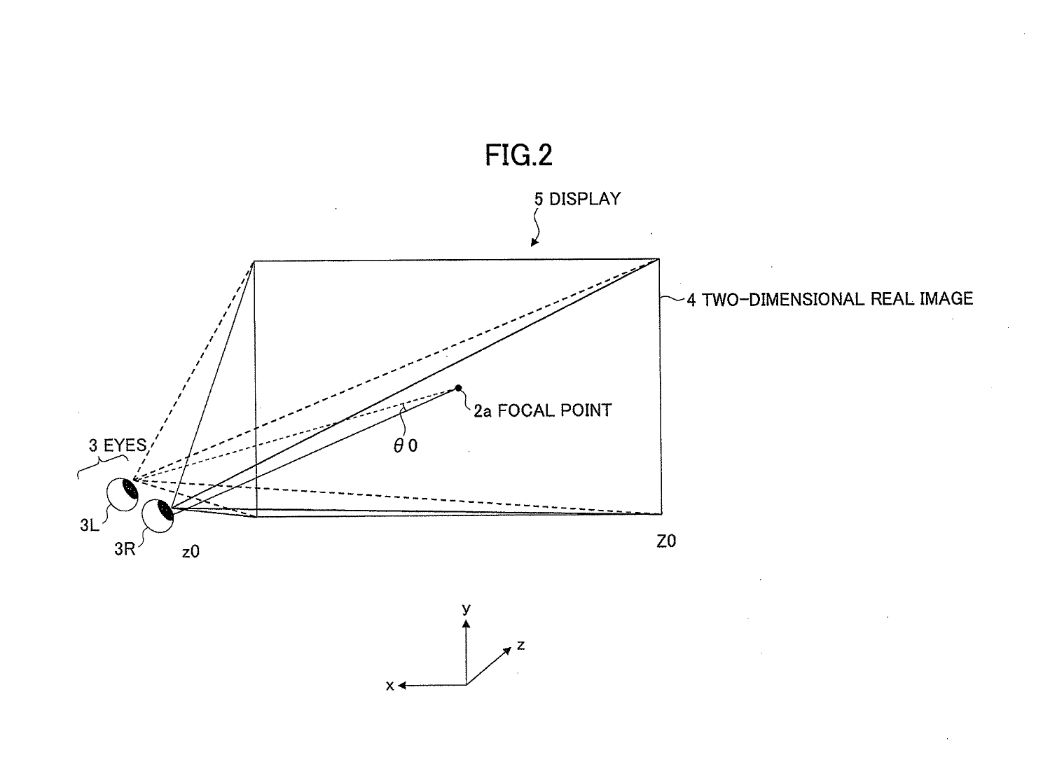

FIG. 2 three-dimensionally illustrates the relationship between display information that is regularly displayed and the positions of the user's eyes. The user views the two-dimensional real image 4 with his left eye 3L and right eye 3R (hereinafter, collectively referred to as eyes 3) to recognize the size of the display screen image of the two-dimensional real image 4 in the x axial direction and the y axial direction. The length between the eyes 3 and the focal point 2a of the two-dimensional real image 4 is recognized according to the convergence angle θ0, as described with reference to FIG. 1.

Next, a description is given of a case where the focal position of the user is changed to a position farther away from or closer to the display position Z0 in the present embodiment.

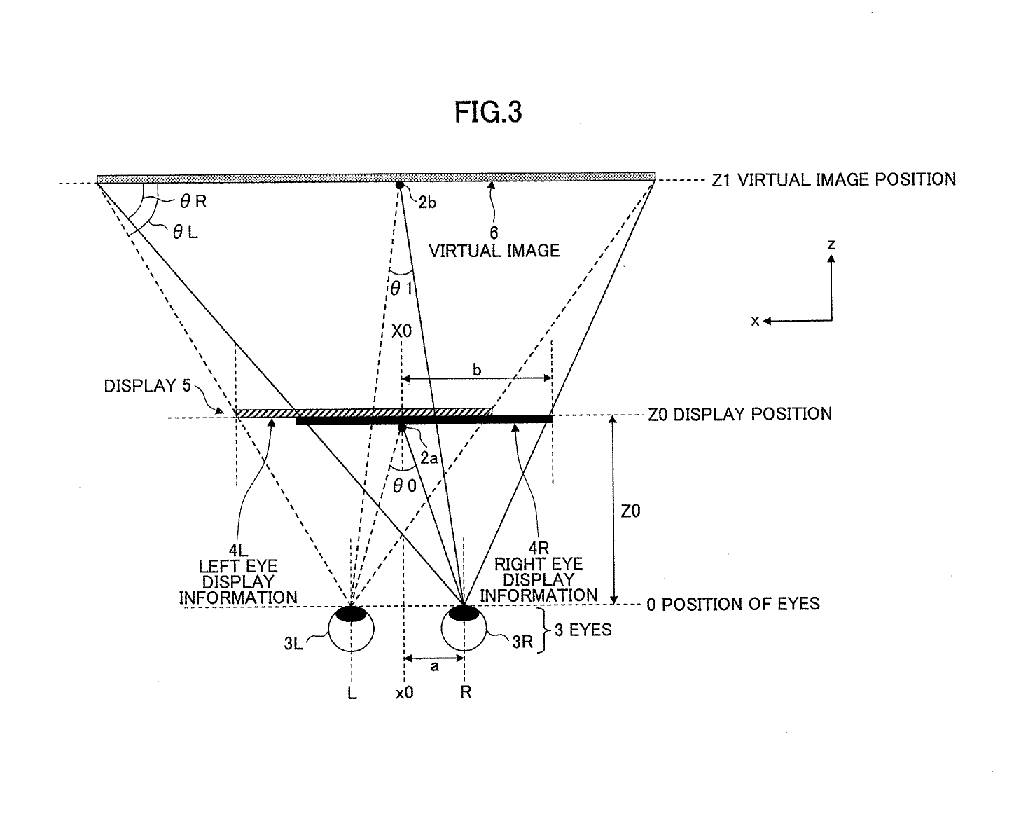

FIG. 3 illustrates a modification of the focal position where the length between the eyes 3 and the display information is extended. In FIG. 3, elements corresponding to those of FIG. 1 are denoted by the same reference numerals. In FIG. 3, left eye display information 4L and right eye display information 4R are generated based on the original display information, and are displayed at the display position Z0. The left eye display information 4L and right eye display information 4R are generated for the purpose of displaying a virtual image 6 that is formed by extending the length from the position 0 of the eyes 3 based on the desired magnification ratio. The virtual image 6 is displayed as a three-dimensional image at a virtual image position Z1.

At the display position Z0, the left eye display information 4L and the right eye display information 4R appear to be displaced from one another in the x axis direction. Accordingly, the display information generated by enlarging the original display information by m=Z1/Z0, is displayed as illustrated at the virtual image position Z1.

The position data of the right eye display information 4R at the display position Z0, when the virtual image 6 is viewed from the position of the right eye 3R, is calculated based on the geometric positions corresponding to FIG. 2. The position data with respect to the left eye 3L is acquired by the same calculation method.

In order to display the virtual image 6 that is enlarged by a desired magnification ratio m at the virtual image position Z1, the right eye display information 4R is positioned and displayed at the display position Z0 in such a manner that a straight line extending from the left edge of the right eye display information 4R to the left edge of the virtual image 6 and the virtual image position Z1 form an angle θR. Furthermore, with respect to the virtual image 6, the left eye display information 4L is positioned and displayed at the display position Z0 in such a manner that a straight line extending from the left edge of the left eye display information 4L to the left edge of the virtual image 6 and the virtual image position Z1 form an angle θL.

According to the virtual image 6 displayed at the virtual image position Z1, the focal point 2a at the display position Z0 changes to a focal point 2b. Thus, the user's brain detects the convergence angle θ1 formed by his left eye 3L and right eye 3R, and perceives that information is displayed at the virtual image position Z1, which is farther away than the position Z0.

Accordingly, the focal point of the user is changed to a position that is farther away, so that the focal position is not fixed at the same position (not fixed at the focal point 2a at the display position Z0).

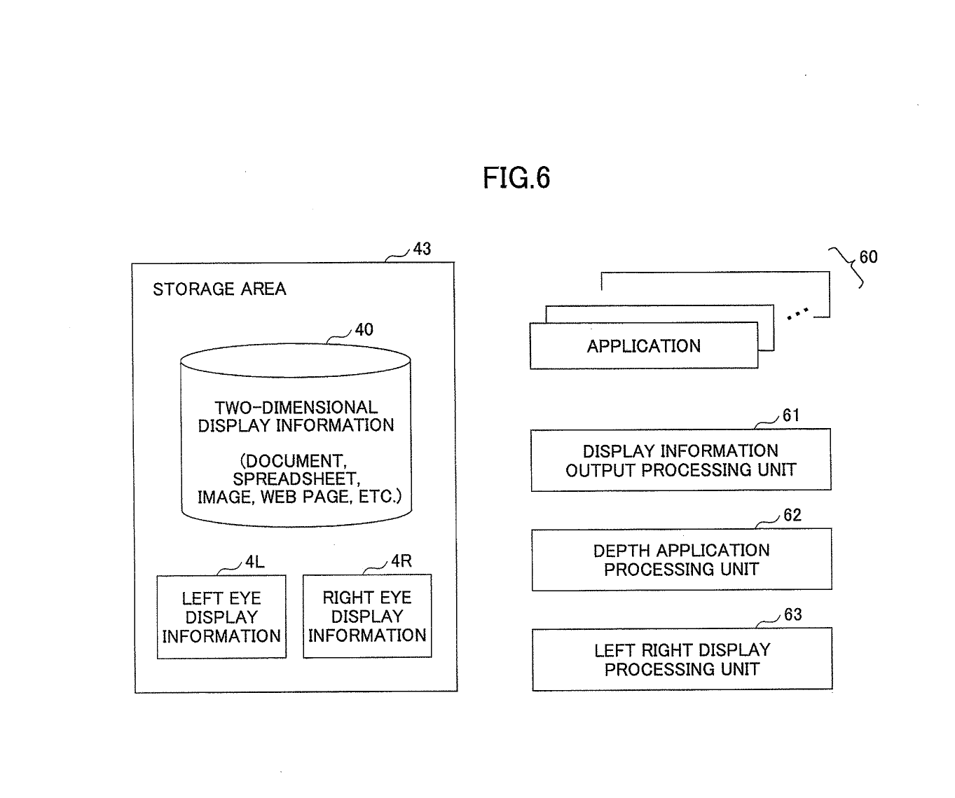

In the present embodiment, the original display information may be, for example, document data, spreadsheet data, image data, and Web data, which is created in a predetermined file format with the use of a corresponding application 60 (see FIG. 6). Hereinafter, the same applies to two-dimensional display information.

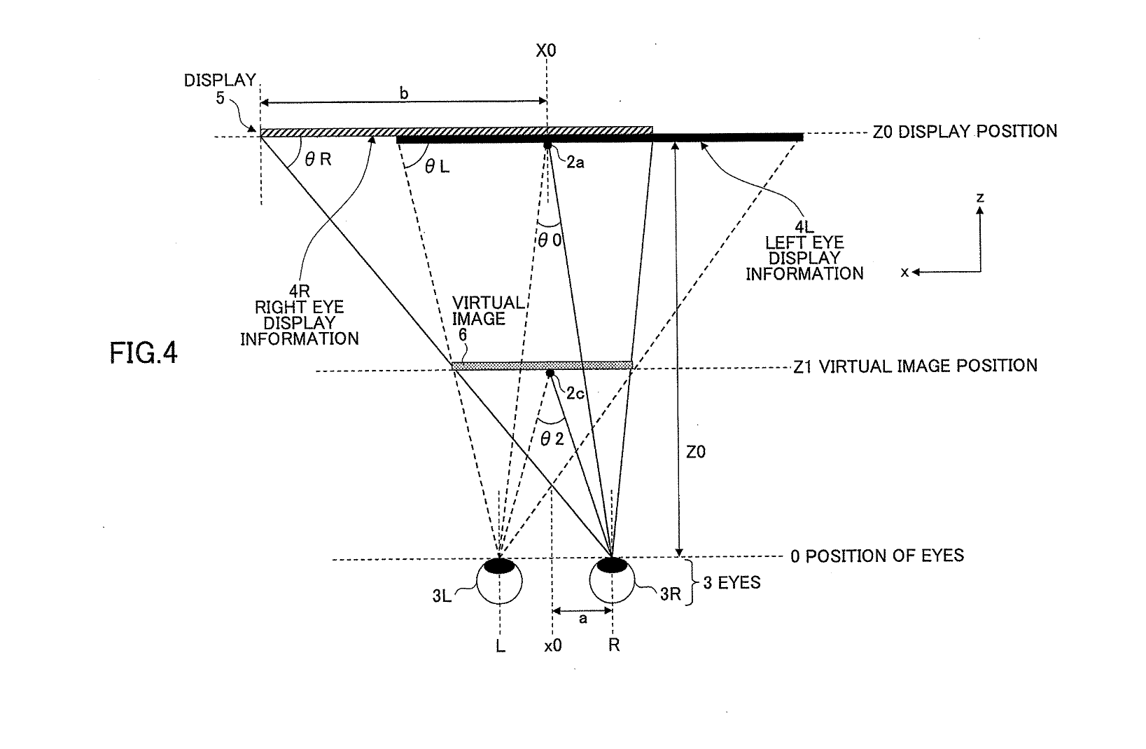

FIG. 4 illustrates a modification of the focal position where the length between the eyes 3 and the display information is reduced. In FIG. 4, elements corresponding to those of FIG. 3 are denoted by the same reference numerals. In FIG. 4, left eye display information 4L and right eye display information 4R are generated based on the original display information, and are displayed at the display position Z0. The left eye display information 4L and right eye display information 4R are generated for the purpose of displaying a virtual image 6 that is formed by reducing the length from the position 0 of the eyes 3 based on the desired magnification ratio. The virtual image 6 is displayed as a three-dimensional image at a virtual image position Z1.

At the display position Z0, the left eye display information 4L and the right eye display information 4R appear to be displaced from one another along the x axis direction. Accordingly, the display information generated by reducing the original display information by m=Z1/Z0, is displayed as illustrated at the virtual image position Z1.

Similar to the case of enlarging the original image information as described with reference to FIG. 3, the position data of the left eye display information 4L and the right eye display information 4R is acquired by making calculations based on the geometric positions.

In order to display the virtual image 6 that is reduced by a desired magnification ratio m at the virtual image position Z1, the right eye display information 4R is positioned and displayed at the display position Z0 in such a manner that a straight line extending from the left edge of the right eye display information 4R to the left edge of the virtual image 6 and the display position Z0 form an angle θR. Furthermore, with respect to the virtual image 6, the left eye display information 4L is positioned and displayed at the display position Z0 in such a manner that a straight line extending from the left edge of the left eye display information 4L to the left edge of the virtual image 6 and the display position Z0 form an angle θL.

According to the virtual image 6 displayed at the virtual image position Z1, the focal point 2a on the display position Z0 changes to a focal point 2b. Thus, the user's brain detects a convergence angle θ2 formed by his left eye 3L and right eye 3R, and perceives that information is displayed at the virtual image position Z1, which is closer than the position Z0.

Accordingly, the focal point of the user is changed to a position that is closer, so that the focal position is not fixed at the same position (not fixed at the focal point 2a at the display position Z0).

In the above examples, the magnification ratio m of the virtual image is m=Z1/Z0, so that the real image on the display is substantially the same size as the original size. If Z1>Z0, the virtual image appears to be enlarged at a position farther away from the original image; however, the method of determining m is not limited thereto. For example, if m=1 and Z1>Z0 are satisfied, a reduced virtual image appears to be at a position farther away than the original image. If m=1 and Z1<Z0 are satisfied, an enlarged virtual image appears to be at a position closer than the original image. That is to say, the virtual image position Z1 and the magnification ratio m may be set separately.

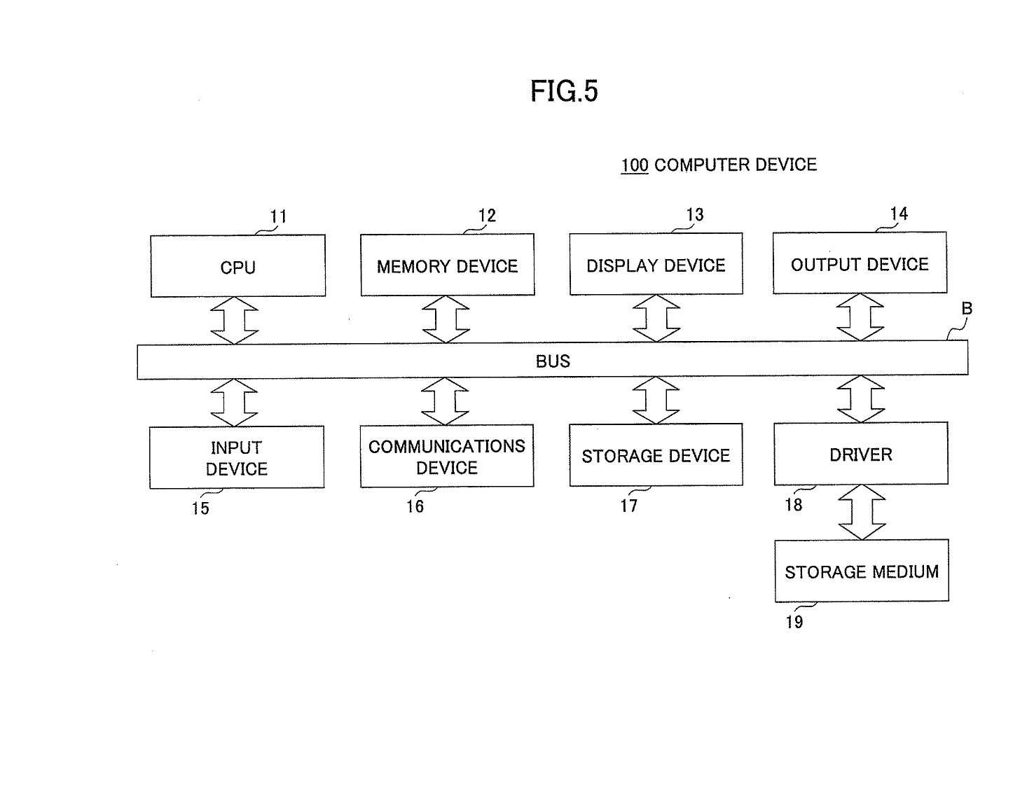

The process according to the above embodiment is implemented by a computer device as illustrated in FIG. 5. FIG. 5 is a block diagram of a hardware configuration of a computer device 100.

As illustrated in FIG. 5, the computer device 100 is a terminal controlled by a computer, and includes a CPU (Central Processing Unit) 11, a memory device 12, a display device 13, an output device 14, an input device 15, a communications device 16, a storage device 17, and a driver 18, which are interconnected by a system bus B.

The CPU 11 controls the computer device 100 according to a program stored in the memory device 12. A RAM (Random Access Memory) and a ROM (Read-Only Memory) are used as the memory device 12. The memory device 12 stores programs executed by the CPU 11, data used for processes of the CPU 11, and data obtained as a result of processes of the CPU 11. Furthermore, part of the area in the memory device 12 is assigned as a working area used for processes of the CPU 11.

The display device 13 includes the display 5 which is a CRT (Cathode Ray Tube) or a LCD (Liquid Crystal Display) that displays various information items, according to control operations by the CPU 11. The display device 13 is to be used as a three-dimensional display device by a method such as a stereogram (parallel method, crossing method), a prism viewer, an anaglyph method (colored spectacles), a polarized spectacle method, a liquid crystal shutter method, and a HMD (head mount display) method, or by software for implementing corresponding functions.

The output device 14 includes a printer, and is used for outputting various information items according to instructions from the user. The input device 15 includes a mouse and a keyboard, and is used by the user to enter various information items used for processes of the computer device 100. The communications device 16 is for connecting the computer device 100 to a network such as the Internet and a LAN (Local Area Network), and for controlling communications between the computer device 100 and external devices. The storage device 17 is, for example, a hard disk device, and stores data such as programs for executing various processes.

Programs for implementing processes executed by the computer device 100 are supplied to the computer device 100 via a storage medium 19 such as a CD-ROM (Compact Disc Read-Only Memory). Specifically, when the storage medium 19 storing a program is set in the driver 18, the driver 18 reads the program from the storage medium 19, and the read program is installed in the storage device 17 via the system bus B. When the program is activated, the CPU 11 starts a process according to the program installed in the storage device 17. The medium for storing programs is not limited to a CD-ROM; any computer-readable medium may be used. Examples of a computer-readable storage medium other than a CD-ROM are a DVD (Digital Versatile Disk), a portable recording medium such as a USB memory, and a semiconductor memory such as a flash memory.

FIG. 6 is a functional block diagram of the computer device 100. As illustrated in FIG. 6, the computer device 100 includes applications 60, a display information output processing unit 61, a depth application processing unit 62, and a left right display processing unit 63, which are implemented by executing programs according to the present embodiment. The computer device 100 further includes a storage area 43 corresponding to the memory device 12 and/or the storage device 17, for storing two-dimensional display information 40 relevant to the two-dimensional real image 4, and the left eye display information 4L and the right eye display information 4R which are generated by a process performed by the computer device 100.

In response to an instruction from a user, the application 60 reads the desired two-dimensional display information 40 from the storage area 43 and causes the display device 13 to display the two-dimensional display information 40. The two-dimensional display information 40 may be document data, spreadsheet data, image data, or Web data, which is stored in a predetermined file format.

In response to a request to display the two-dimensional display information 40 received from the application 60, the display information output processing unit 61 reads the specified two-dimensional display information 40 from the storage area 43, and performs a process of outputting the read two-dimensional display information 40 to the display device 13. The output process to the display device 13 includes expanding the two-dimensional display information 40 into value data expressed by RGB (Red, Green, Blue) in the storage area 43, for displaying the two-dimensional display information 40 on the display 5. The two-dimensional display information 40 that has been expanded into displayable data, is then supplied to the depth application processing unit 62.

The depth application processing unit 62 is a processing unit for applying distance to the two-dimensional display information 40. The depth application processing unit 62 performs enlargement/reduction calculations on the two-dimensional display information 40 processed by the display information output processing unit 61. The enlarged/reduced two-dimensional information at the virtual image position Z1 is converted to the two-dimensional display information at the display position Z0. According to this conversion process, the left eye display information 4L and the right eye display information 4R are generated in the storage area 43.

The left right display processing unit 63 performs a process for simultaneously displaying, on the display device 13, the left eye display information 4L and the right eye display information 4R generated in the storage area 43.

The processes to be achieved by the processing units 61 through 63 are implemented by hardware and/or software. In the hardware configuration of FIG. 5, one or all of the processes to be achieved by the processing units 61 through 63 may be implemented by software. The hardware is not limited to those of FIG. 5. For example, at least one of the processing units 62 and 63 may be established as a dedicated graphic processor (GPU), and may be incorporated in various display devices.

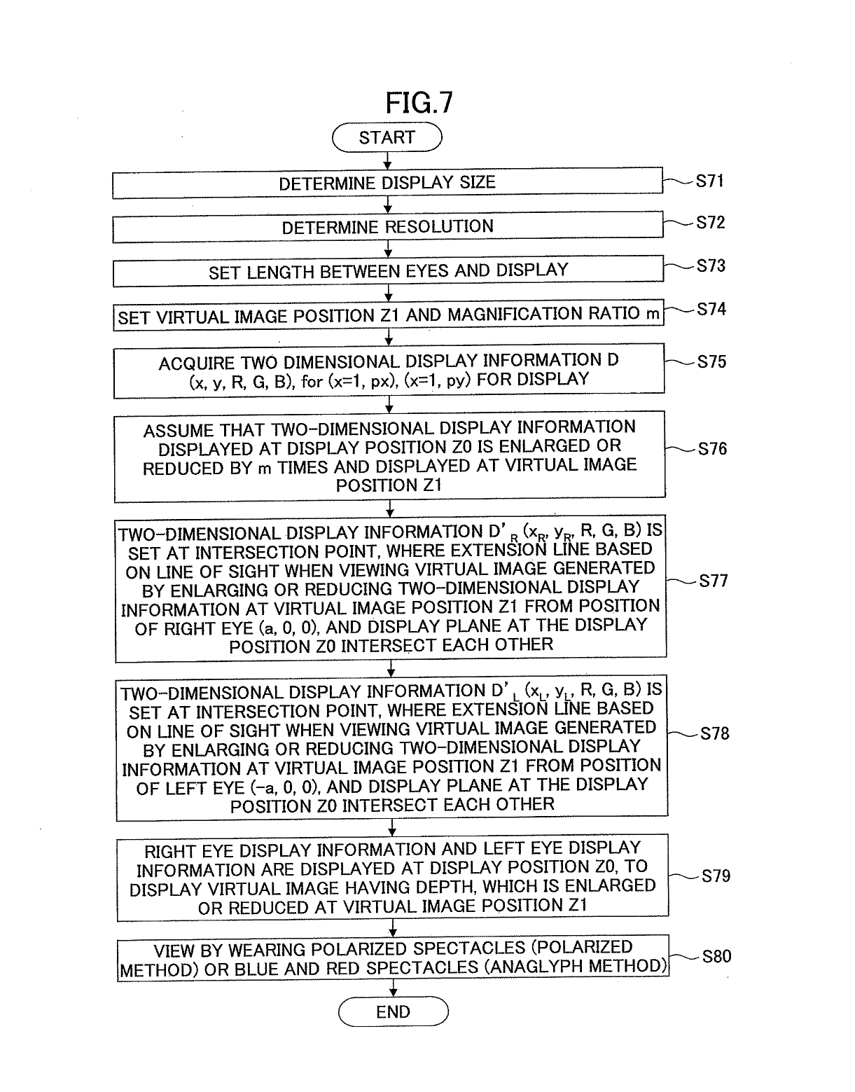

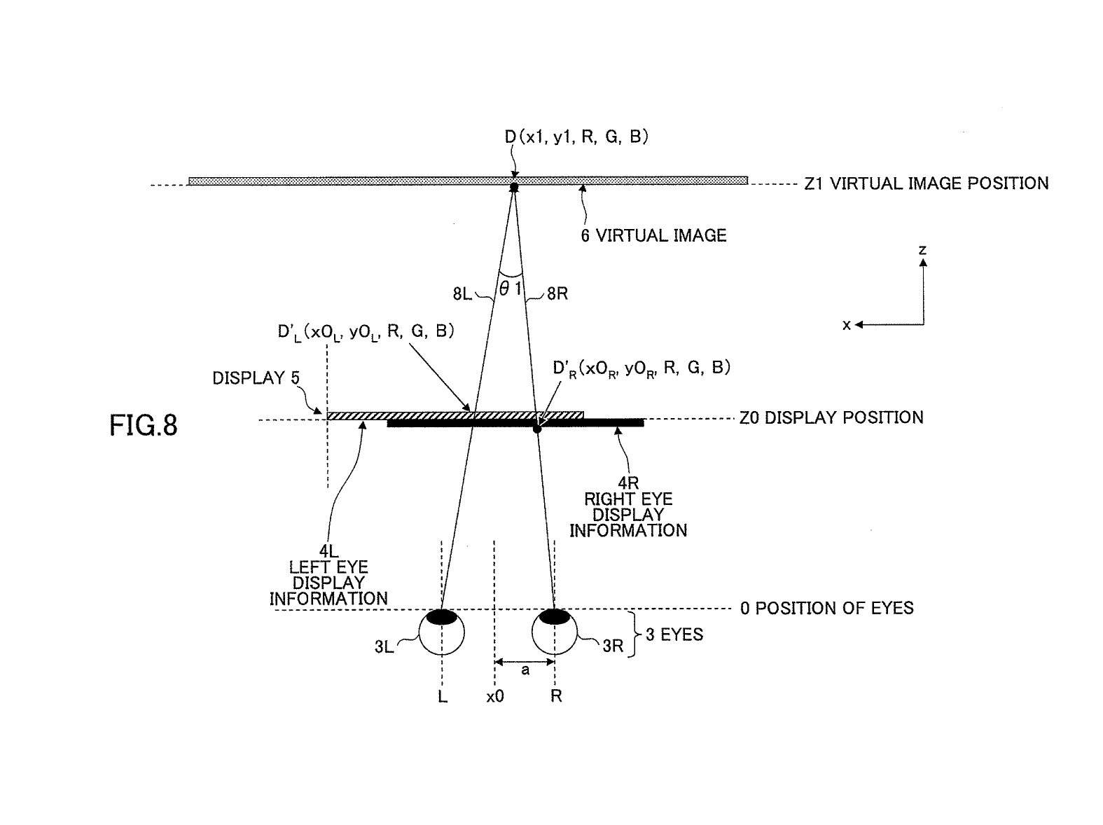

Next, a description is given of a process of applying depth (distance) to the two-dimensional display information according to the present embodiment and displaying the resultant display information, with reference to FIG. 7. Furthermore, FIG. 8 illustrates an example where depth is applied to the two-dimensional display information in the extended direction.

FIG. 7 is a flowchart for describing a process according to the present embodiment. As illustrated in FIG. 7, in response to a request to display specified two-dimensional display information 40, the display information output processing unit 61 determines the display size (step S71). The display size is acquired from the display device information relevant to the display device 13. In the display size, the display width corresponds to two times a width b indicated in FIG. 1. Alternatively, a size that is set in the storage area 43 in advance may be read.

The display information output processing unit 61 further determines the resolution (step S72). Similar to step S71, the resolution is acquired from the display device information. Alternatively, a pixel number corresponding to a resolution that is set in the storage area 43 in advance may be read.

Then, the display information output processing unit 61 expands the specified two-dimensional display information 40 as RGB data in the storage area 43, based on the acquired display size and resolution. The colors are expressed by a value ranging from 0 to 25 in the pixels.

Next, the depth application processing unit 62 sets the length between the eyes 3 and the display 5 (step S73). Alternatively, a predetermined value corresponding to a length that is set in the storage area 43 in advance may be read. Furthermore, a display position Z0 corresponding to a length may be acquired based on information acquired from a sensor described below.

The depth application processing unit 62 sets the virtual image position Z1 and a magnification ratio m (step S74).

The depth application processing unit 62 acquires, from the storage area 43, the two dimensional display information D (x, y, R, G, B) which has been expanded for the purpose of being displayed (step S75). By the two dimensional display information D (x, y, R, G, B), RGB values are indicated for the pixels and the pixels are identified by x=1 through px along an x axis direction and y=1 through py along a y axis direction in the display area. The pixels are indicated by values of zero through 255 for the respective colors of red, blue, and green, for example.

It is assumed that the depth application processing unit 62 enlarges or reduces the two-dimensional display information 40 displayed at the display position Z0 by m times, and displays the enlarged or reduced two-dimensional display information 40 at the virtual image position Z1 (step S76). When the two-dimensional display information 40 is enlarged, as illustrated in FIG. 8, it is assumed that the depth application processing unit 62 displays the two-dimensional display information 40 at the virtual image position Z1, which is farther away than the display position Z0.

The depth application processing unit 62 sets two-dimensional display information D′_{R} (x_{R}, y_{R}, R, G, B) at an intersection point, where an extension line based on the line of sight when viewing the virtual image 6 generated by enlarging or reducing the two-dimensional display information 40 at the virtual image position Z1 from the position of the right eye 3R (a, 0, 0), and the display plane at the display position Z0 intersect each other (step S77). In the case of enlarging the two-dimensional display information 40, as illustrated in FIG. 8, the two-dimensional display information D′_{R}(x0_{R}, y0_{R}, R, G, B) is set at an intersection point, where an extension line 8R based on the line of sight when viewing virtual image information D(x1, y1, R, G, B) of the virtual image 6 from the right eye 3R, and the display plane at the display position Z0 intersect each other. By shifting the line of sight in a predetermined order, two-dimensional display information D′_{R} is set in the pixels of the display plane at the display position Z0. Accordingly, the right eye display information 4R is created, and the created right eye display information 4R is stored in the storage area 43.

Similarly, the depth application processing unit 62 sets two-dimensional display information D′_{L} (x0_{L}, y0_{L}, R, G, B) at an intersection point, where an extension line based on the line of sight when viewing the virtual image 6 generated by enlarging or reducing the two-dimensional display information 40 at the virtual image position Z1 from the position of the left eye 3L (−a, 0, 0), and the display plane at the display position Z0 intersect each other (step S78). In the case of enlarging the two-dimensional display information 40, as illustrated in FIG. 8, the two-dimensional display information D′_{L}(x0_{L}, y0_{L}, R, G, B) is set at an intersection point, where an extension line 8L based on the line of sight when viewing virtual image information D(x1, y1, R, G, B) of the virtual image 6 from the left eye 3L, and the display plane at the display position Z0 intersect each other. By shifting the line of sight in a predetermined order, two-dimensional display information D′_{L} is set in the pixels of the display plane at the display position Z0. Accordingly, the left eye display information 4L is created, and the created left eye display information 4L is stored in the storage area 43.

By storing data used for the process of FIG. 7 in the storage area 43 in advance, it is possible to perform the process quickly. Examples of such data are the display size, the resolution, the virtual image position Z1, the magnification ratio m, and corresponding position information indicating how the right eye display information 4R and the left eye display information 4L are displaced with respect to each other. Furthermore, the virtual position Z1, the magnification ratio, and the corresponding position information may be set in a header of a file including the two-dimensional display information created by the application 60, so that a unique virtual image position Z1 is provided for each file. Furthermore, when plural frames are applied as described below, a virtual image position Z1 may be set for each frame.

Next, the left right display processing unit 63 reads the right eye display information 4R and the left eye display information 4L from the storage area 43, and displays the right eye display information 4R and the left eye display information 4L at the display position Z0 (display 5), to display the virtual image 6 having depth, which is enlarged or reduced at the virtual image position Z1 (step S79). In the case of enlarging the image, as illustrated in FIG. 8, the right eye display information 4R is displaced toward the right, and the left eye display information 4L is displaced toward the left, when displayed on the display 5. Accordingly, three-dimensional display information (virtual image 6) having depth is displayed at the virtual image position Z1, which is farther away from the display position Z0.

The user views the virtual image 6 at the virtual image position Z1 by wearing polarized spectacles in the case of a polarized method or colored (blue and red) spectacles in the case of an anaglyph method (step S80).

The virtual image position Z1 is to be at a length that is easy to view for the user, which is specified by the user in advance. For example, the virtual image position Z1 is set to be one meter from the user.

The above describes a case of displaying one set of the two-dimensional display information 40. In the following, other display examples are described.

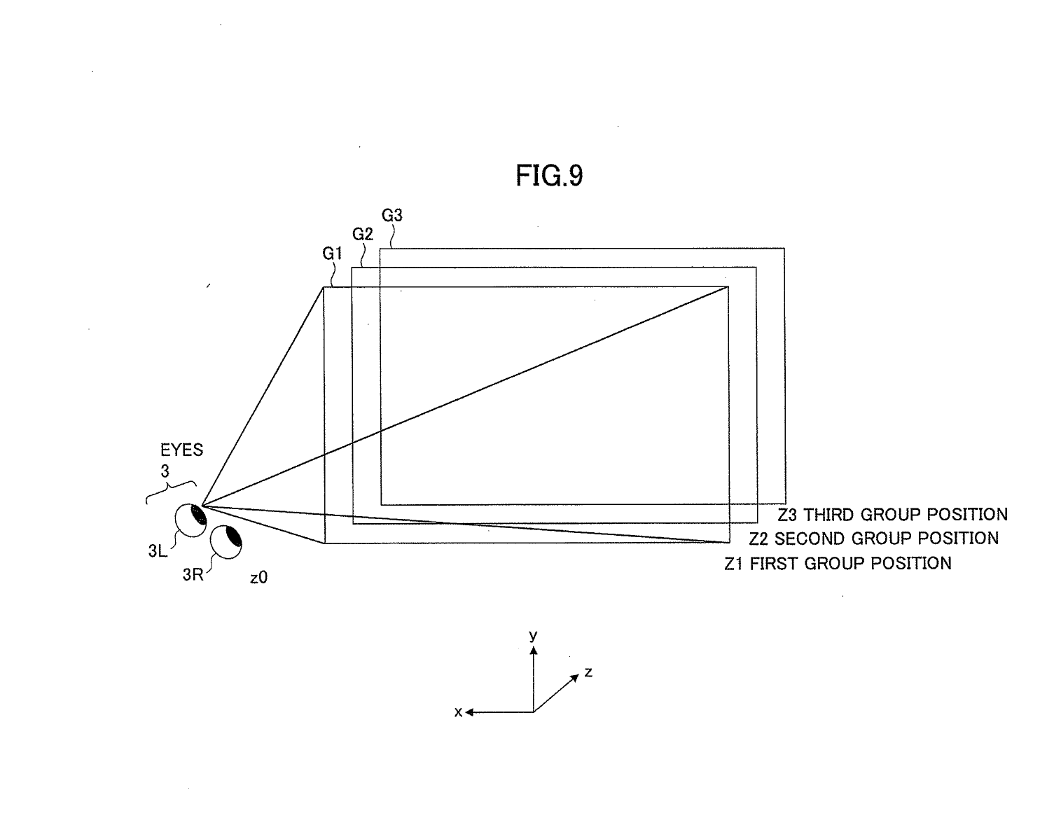

FIG. 9 illustrates a display example of plural sets of two-dimensional display information. As illustrated in FIG. 9, plural sets of two-dimensional display information are divided into three groups, i.e., a first group G1, a second group G2, and a third group G3. Different virtual image positions are set for the respective groups.

At a first group position Z1, a first group G1 corresponding to three-dimensional display information is displayed. At a second group position Z2, which is a position farther away than the first group position Z1, a second group G2 corresponding to three-dimensional display information is displayed. At a third group position Z3, which is a position farther away than the second group position Z2, a third group G3 corresponding to three-dimensional display information is displayed.

By displaying the first group at a position closer than the real image, and displaying the third group at a position farther than the real image, a sense of perspective is further emphasized.

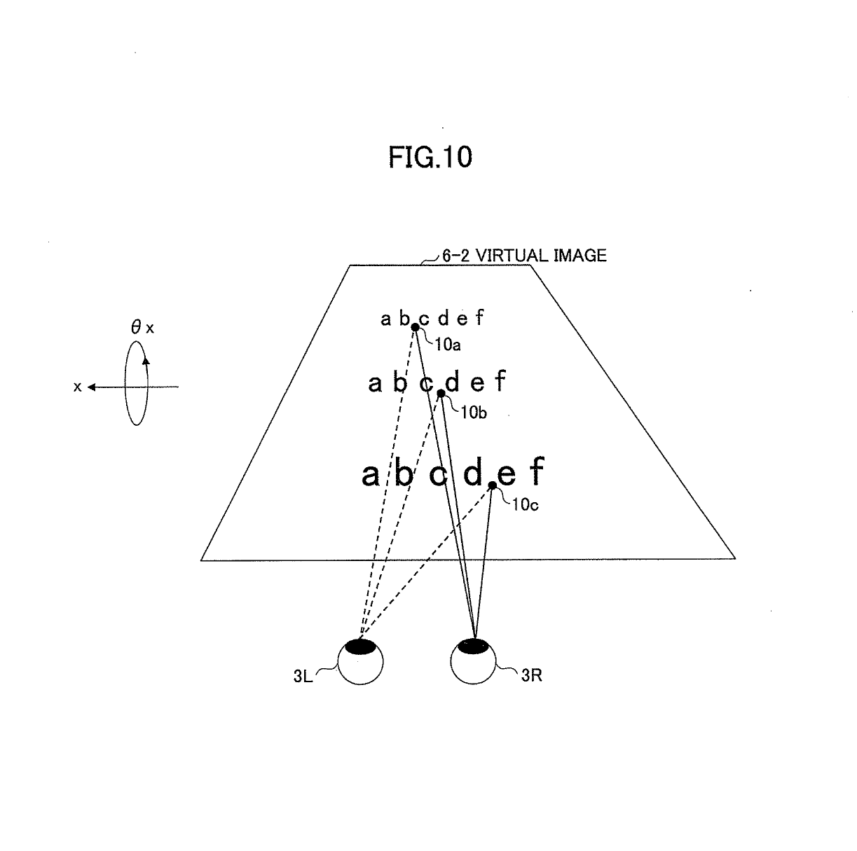

FIG. 10 is a display example in which the focal length is changed within a single virtual image. FIG. 10 illustrates an example where the two-dimensional display information 40 is document data. The document data of a virtual image 6-2 is displayed by rotating the two-dimensional display information 40 on the x axis, such that the top appears to be the farthest position of the document and the document appears to be coming closer toward the bottom.

When the user views the document displayed by the virtual image 6-2 from top to bottom, the user reads the document by different senses of perspective at the respective positions of a focal point 10a, a focal point 10b, and a focal point 10c. The focal point 10a appears to be farthest from the user's eyes 3, while the focal point 10c appears to be closest to the user's eyes 3, so that the focal length is varied naturally. Accordingly, compared to the case of viewing an image at a fixed length for a long time, the burden on the eyes 3 is reduced. The same effects are achieved in a case where the two-dimensional display information 40 is rotated on the y axis, in which case a virtual image gives a different sense of perspective on the left side and right side. The two-dimensional display information 40 may be rotated in a three-dimensional manner on the x axis and/or the y axis.

In the above description, it is assumed that the eyes 3 and the display 5 are at given positions. However, there may be a case where the position of the eyes 3 becomes displaced from the supposed position. In this case, the virtual image position Z1 of the virtual image 6 is displaced. Therefore, if the position of the eyes 3 is displaced, the virtual image 6 appears to be displaced as well. A description is given of a correction method using position sensors.

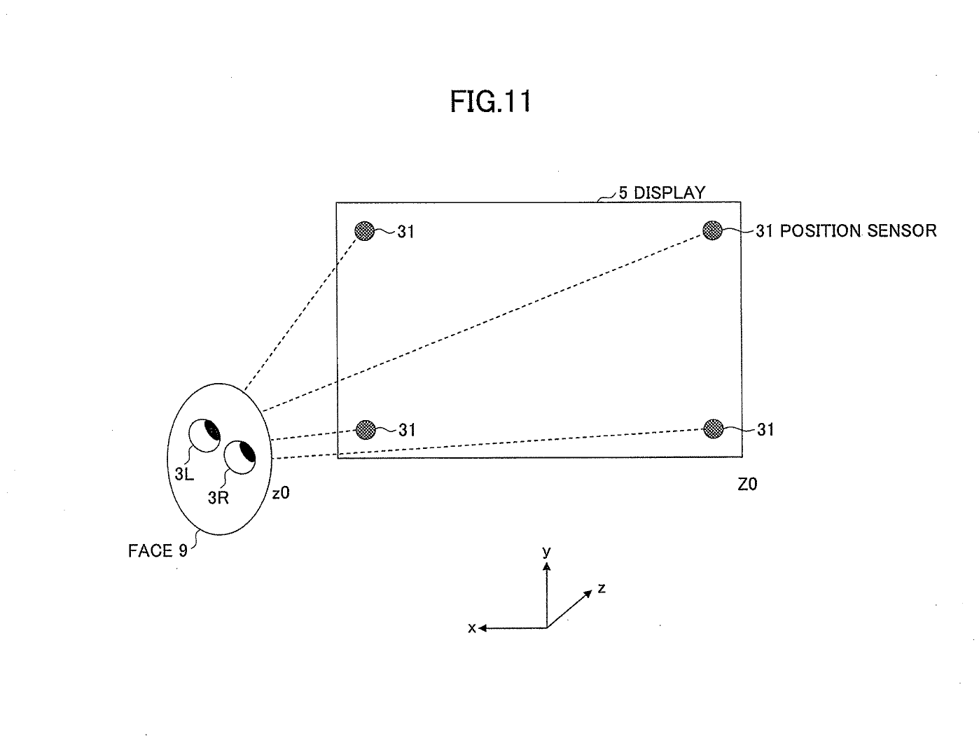

FIG. 11 illustrates positions of position sensors. In FIG. 11, position sensors 31 are disposed at the four corners of a display 5.

The position sensors 31 disposed at the four corners of the display 5 detect the length from the display 5 to the user's face 9. The CPU 11 calculates the relative position of the face 9 based on the lengths detected by the position sensors 31, and sets the display position Z0. By determining the position of the virtual image 6 based on the display position Z0 in the above manner, it is possible to prevent the video image from moving due to the movement of the eyes 3.

Another method of detecting the relative position of the face 9 is to install a monitor camera in the display 5, perform face authentication by the video image of the monitor camera, and determine the positions of the eyes 3, to calculate the length from the face 9 to the display 5.

Furthermore, user information for performing various types of face authentication may be stored in the storage area 43 in association with the user ID. The user information may include the interval between the right eye 3R and the left eye 3L of the user, and face information relevant to the face 9 for performing face authentication. If the computer device 100 is provided with a fingerprint detection device, fingerprint information may be stored in the user information in advance, for performing fingerprint authentication.

FIG. 11 indicates an example of disposing position sensors 31 in the display 5. However, in another example, a position sensor may be disposed near the user's eyes 3 to measure the relative position of the display 5 from the user's eyes 3 or face 9. By setting the measured relative position as the display position Z0, it is possible to prevent the virtual image 6 from moving due to the movement of the eyes 3.

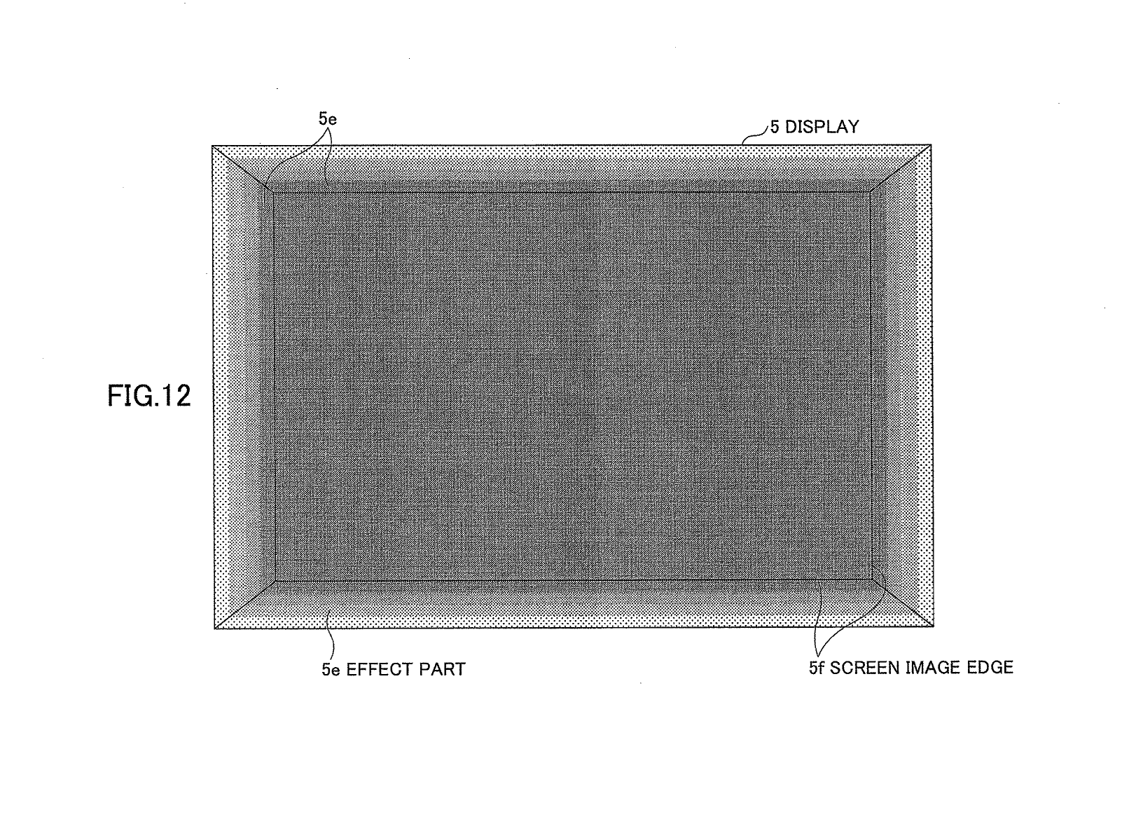

A description is given of an effect part of the display 5 used for giving an even more natural sense of distance to the user. FIG. 12 illustrates an example of an effect part 5e for giving a more natural sense of distance. By providing an effect part 5e having gradation along the periphery of the display 5 as illustrated in FIG. 12, a natural sense of distance is given when the user views the displayed virtual image 6. The effect part 5e may be a frame having a shape according to the periphery of the display 5, or the effect part 5e may be a transparent rectangular member according to the size of the display 5.

The gradation has colors that become thicker or thinner from the periphery of the effect part 5e toward the inner part of the effect part 5e in accordance with the background color of the display 5, so that the color of the effect part 5e matches a screen image edge 5f at the inner part. By making the color become thicker from the periphery toward the inner part of the effect part 5e, it becomes easier to set the focal point of the user at a far position. Conversely, by making the color become thinner from the periphery toward the inner part of the effect part 5e, it becomes easier to set the focal point of the user at a near position. Furthermore, as to the gradation from the periphery of the effect part 5e toward the screen image edge 5f, the front may have an effect for giving a sense of distance at a far position, while the back may have an effect for giving a sense of distance at a near position, and the user may select either one.

The background of the display screen image of the display 5 may include repeated patterns such as a checkered pattern that gives a sense of distance. This may be implemented by software for making the ground part of the original display information transparent, and superposing the display information on the checkered background.

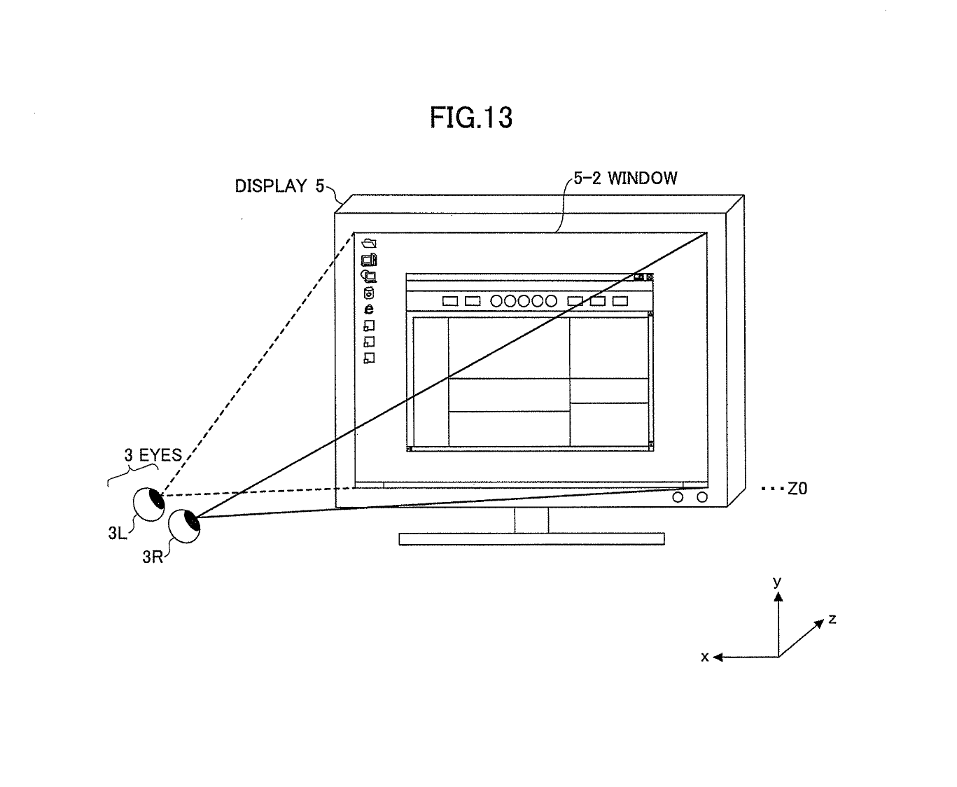

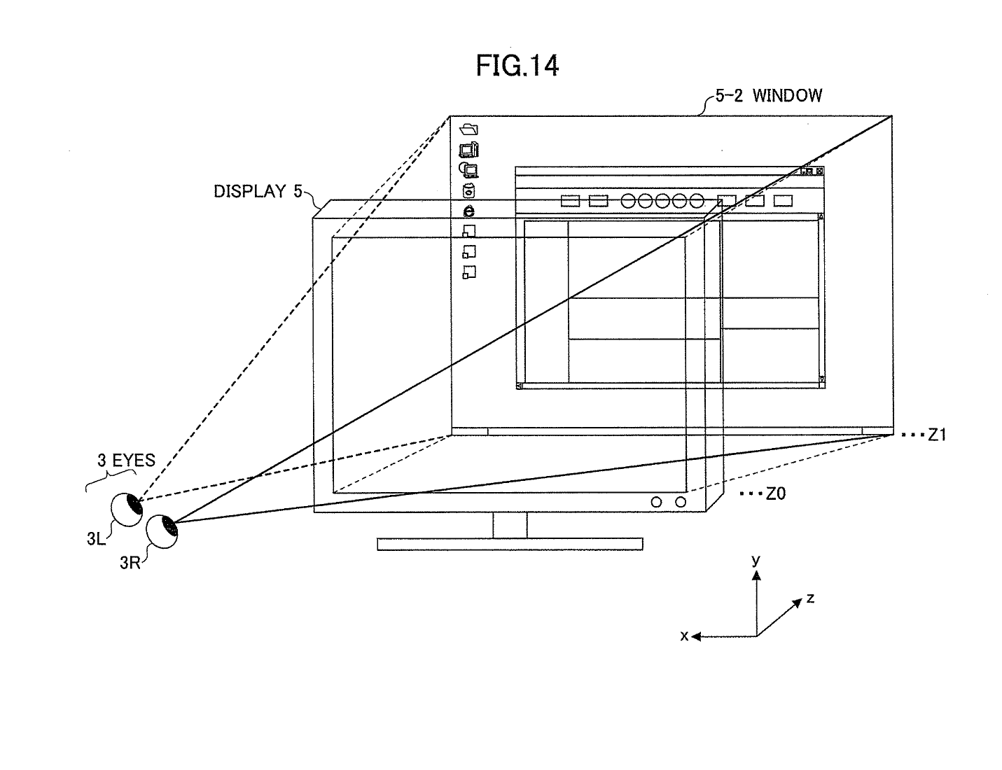

Next, a description is given of effects of the present embodiment. First, a display example of the overall display screen image of the display 5 is given with reference to FIGS. 13 and 14. In FIGS. 13 and 14, the entire display screen image of the display 5, in which a Web page is displayed in a window 5-2, is the two-dimensional real image 4.

FIG. 13 illustrates an example of a regular display of the two-dimensional real image 4. In FIG. 13, at the display position Z0, there is displayed a screen image in which the two-dimensional real image 4 relevant to the entire screen image is regularly displayed without applying depth. The focal point of the user is at the display position Z0 of the entire display screen image, whether the user is viewing the outside or the inside of the window 5-2.

Meanwhile, FIG. 14 illustrates an example of a display in which depth is applied to the two-dimensional real image 4. In FIG. 14, the two-dimensional real image 4 relevant to the entire display screen image is enlarged and made to have depth, and is displayed at the virtual image position Z1. The user's focal point is at the display position of the entire display screen image whether the user is viewing the outside or the inside of the window 5-2, which is at the virtual image position Z1 that is farther away than the display position Z0.

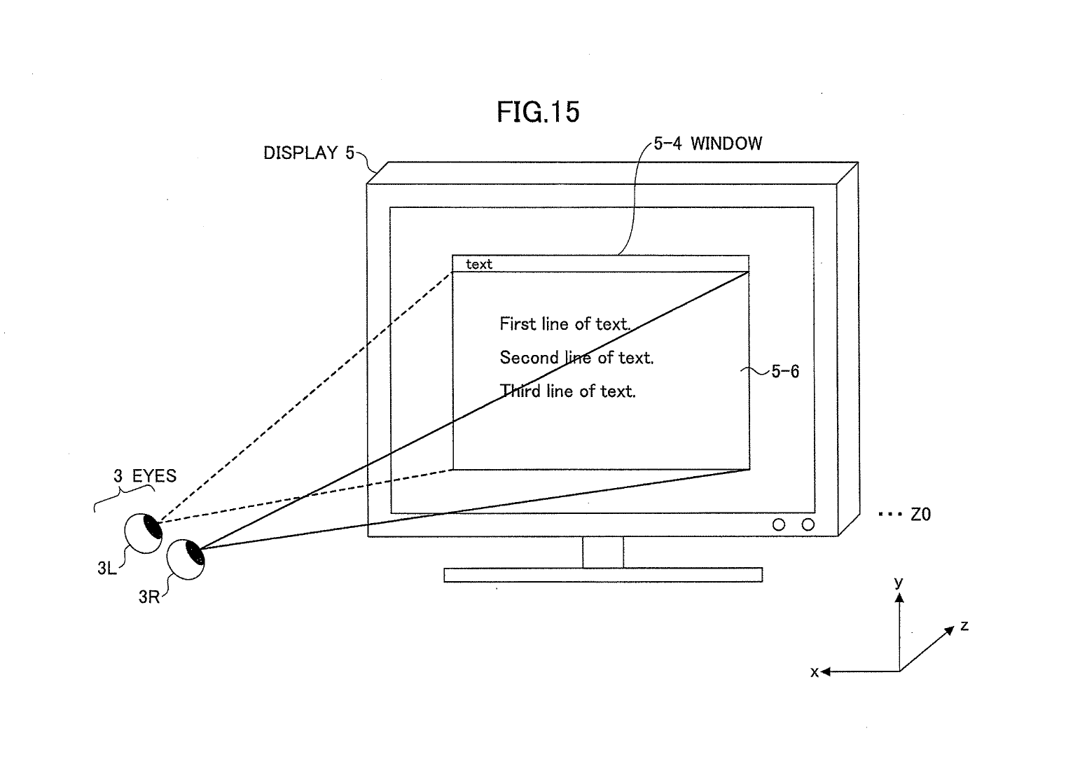

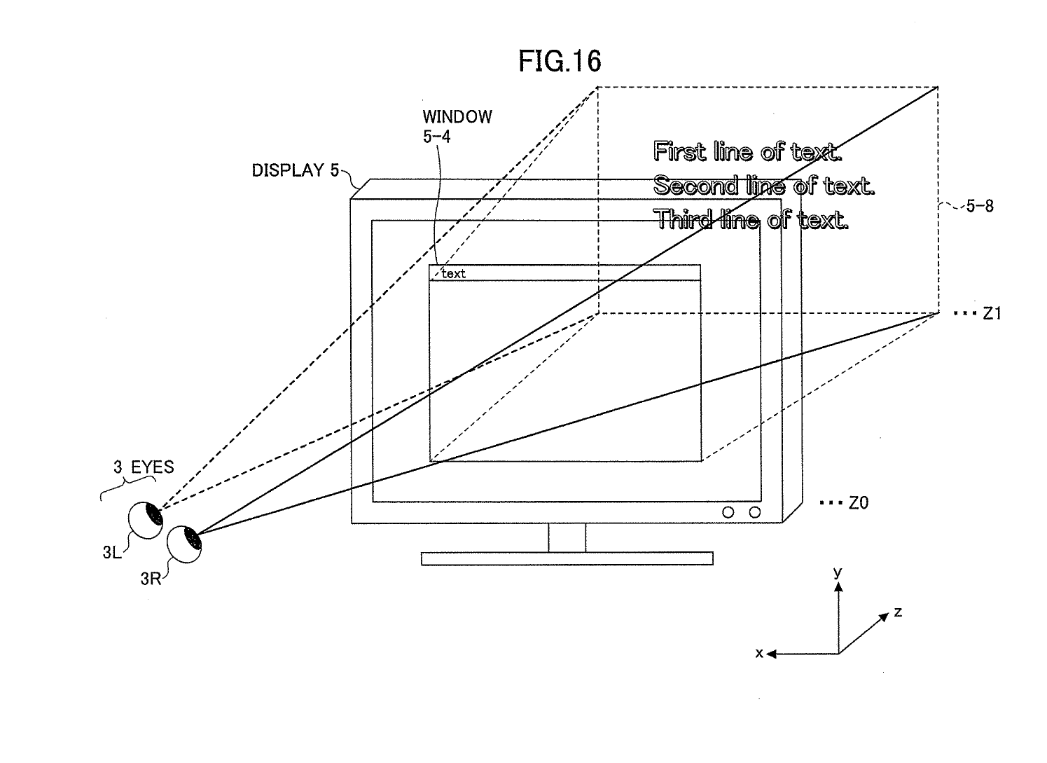

Next, with reference to FIGS. 15 and 16, a description is given of a display example of display information inside a window displayed on a display screen image. FIGS. 15 and 16 illustrate an example where the two-dimensional real image 4 is document data such as text displayed inside a window 5-4 in a display screen image of the display 5.

FIG. 15 illustrates another example of a two-dimensional real image 5-6 that is regularly displayed. In FIG. 15, at the display position Z0, a screen image of display information relevant to the entire display screen image is regularly displayed without applying depth. The focal point of the user is at the display position Z0 of the entire display screen image, whether the user is viewing the outside or the inside of the window 5-4.

Meanwhile, FIG. 16 illustrates another display example in which depth is applied to a two-dimensional real image. In FIG. 16, a virtual image 5-8 is formed by enlarging and applying depth to the two-dimensional real image 5-6 inside a window 5-4 in the display screen image, and the virtual image 5-8 is displayed at the virtual image position Z1. The user's focal point is at a display position Z0 when the user views the outside of the window 5-4. The user's focal point is at a virtual image position Z1, which is farther away than the display position Z0, when the user views a virtual image 5-8 that is inside the window 5-4. The user's focal length changes as the user's view switches between the outside and the inside of the window 5-4, and therefore it is possible to reduce the state where the focal length is fixed.

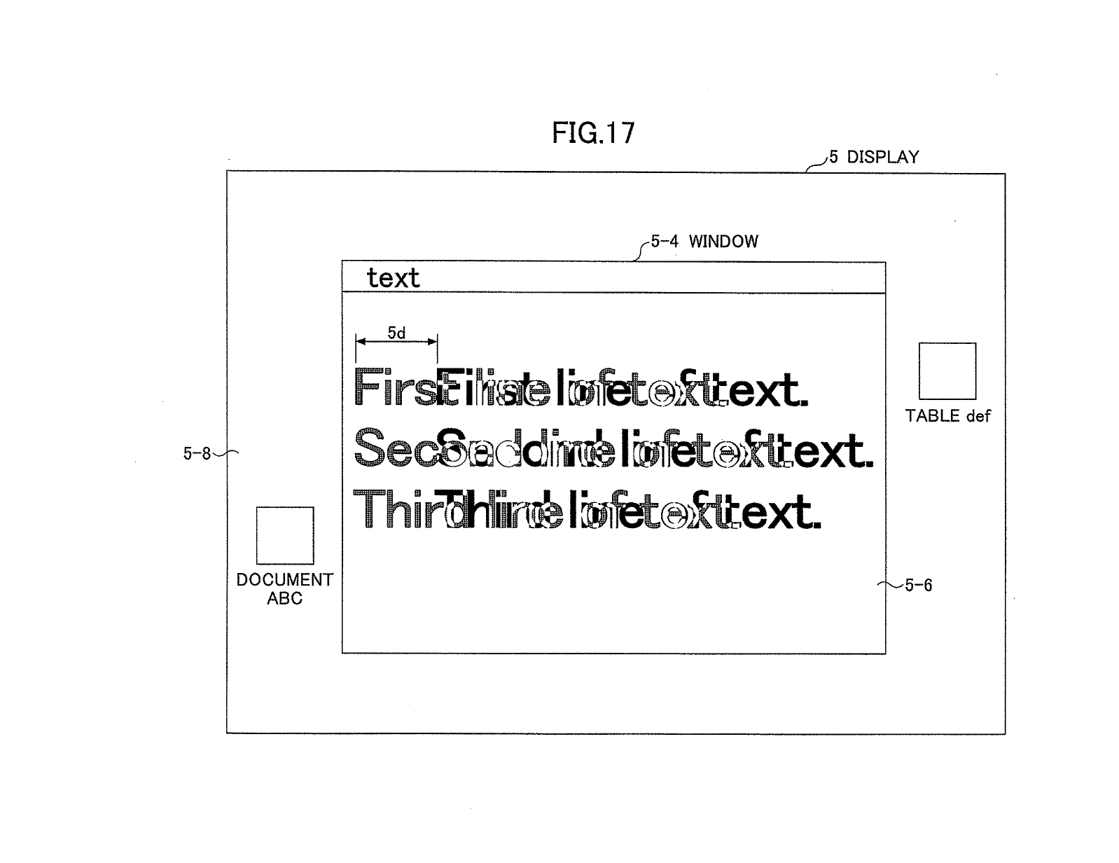

FIG. 17 illustrates a display example of display information inside a processed window. The left eye display information 4L and the right eye display information 4R are generated with respect to the two-dimensional display information 40 relevant to a two-dimensional real image 5-6 inside the window 5-4 illustrated in FIG. 16. The generated left eye display information 4L and right eye display information 4R are superposed and displayed inside the window 5-4 of the display 5. According to the virtual image position Z1 and the magnification ratio m, a displacement 5d between the left eye display information 4L and the right eye display information 4R in the horizontal direction is determined.

Meanwhile, in the display 5, display information 5-8 outside the window 5-4 is regularly displayed. Therefore, characters such as “DOCUMENT ABC” and “TABLE def” are displayed without any modification, because the corresponding two-dimensional display information 40 is set to have a magnification ratio of one, and no corresponding left eye display information 4L or right eye display information 4R are generated.

By applying the present embodiment to part of a display screen image of the display 5, when the user wears dedicated spectacles to view the display 5, the user's focal length is changed between the state where the user views the display information 5-8 such as “DOCUMENT ABC” and “TABLE def” outside the window 5-4 and the state where the user views the display information 5-6 inside the window 5-4.

As described above, in the present embodiment, by enlarging and applying depth to the two-dimensional real image 4, it is possible to convert the two-dimensional display information relevant to the two-dimensional real image 4 into three-dimensional display information. The present embodiment is also applicable to three-dimensional display information, which is converted into a data format for displaying predetermined three-dimensional data in the display 5. Next, a description is given of a method enlarging and applying depth to a three-dimensional image displayed based on three-dimensional display information.

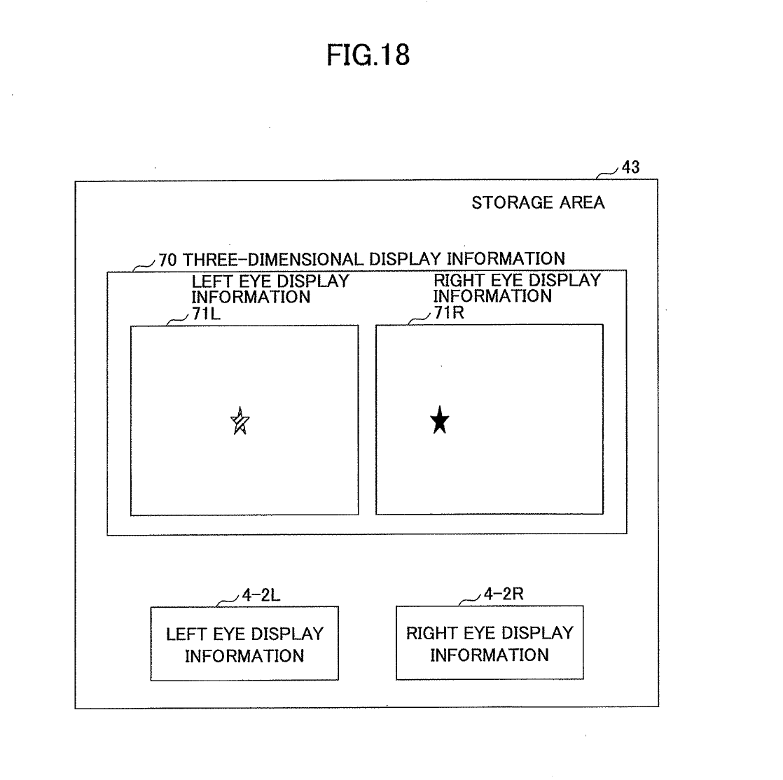

FIG. 18 illustrates an example of a data configuration of a storage area for storing three-dimensional display information. As illustrated in FIG. 18, three-dimensional display information 70 is stored in advance in the storage area 43. The three-dimensional display information 70 includes right eye display information 71R and left eye display information 71L for displaying a three-dimensional image at a display position Z0. The user views the right eye display information 71R and the left eye display information 71L that are simultaneously displayed on the display 5, and thus views a three-dimensional image at the display position Z0.

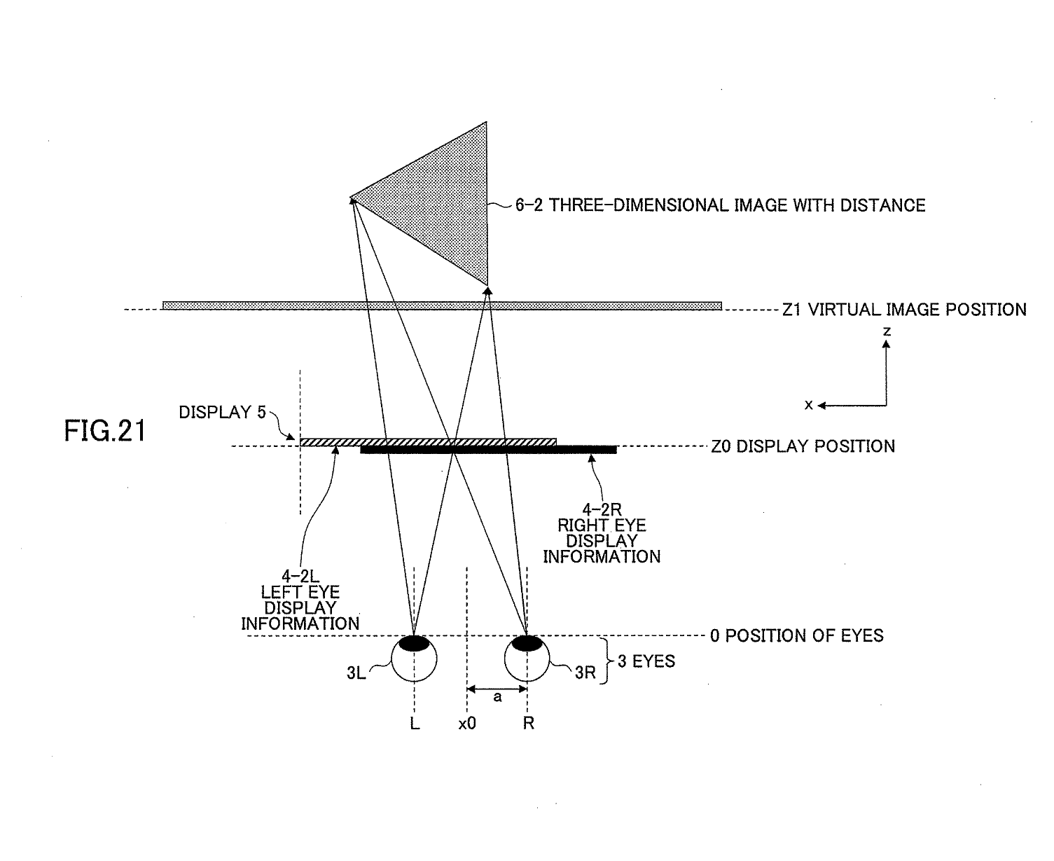

Left eye display information 4-2L and right eye display information 4-2R are respectively generated by enlarging and applying depth to the right eye display information 71R and the left eye display information 71L corresponding to the three-dimensional display information 70. When the left eye display information 4-2L and the right eye display information 4-2R are displayed at the display position Z0, the user views, at the virtual image position Z1, a three-dimensional image 6-2 (FIG. 21) that is enlarged and that has depth (distance). Accordingly, the focal point becomes farther away than the display position Z0.

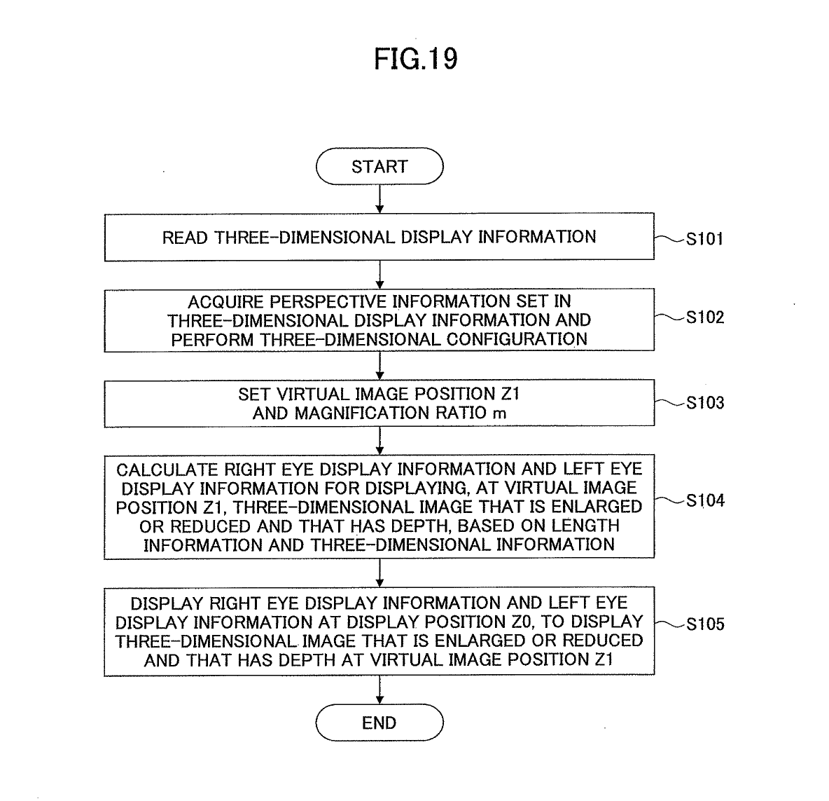

FIG. 19 is a flowchart for describing a method of enlarging or reducing and applying depth to a three-dimensional image. The computer device 100 reads the three-dimensional display information 70 relevant to a three-dimensional image displayed at the display position Z0 stored in the storage area 43 (step S101), acquires perspective information set in the three-dimensional display information 70, and performs three-dimensional configuration (step S102). Then, the computer device 100 sets the virtual image position Z1 and the magnification ratio m (step S103). The perspective information includes information indicating the displacement between left and right images. The virtual image position Z1 and the magnification ratio m may be set separately from each other.

Subsequently, the computer device 100 calculates the right eye display information 4-2R and the left eye display information 4-2L for displaying, at the virtual image position Z1, the three-dimensional image 6-2 (FIG. 21) that is enlarged or reduced and that has depth (distance) (step S104). This calculation is performed based on length information relevant to the length to the virtual image position Z1 and three-dimensional information obtained by performing three-dimensional configuration. The depth application processing unit 62 performs the same process as steps S77 and S78 described with reference to FIG. 7 to generate the right eye display information 4-2R and the left eye display information 4-2L, and stores the generated information in the storage area 43.

Next, the left right display processing unit 63 reads the right eye display information 4R and the left eye display information 4L from the storage area 43, and displays this information at the display position Z0 (display 5), so that the three-dimensional image 6-2 (FIG. 21) that is enlarged or reduced and that has depth (distance) is displayed at the virtual image position Z1 (step S105).

Subsequently, the user views the three-dimensional image 6-2 (FIG. 21) having distance at the virtual image position Z1, by wearing polarized spectacles in the case of a polarized method or colored (blue and red) spectacles in the case of an anaglyph method.

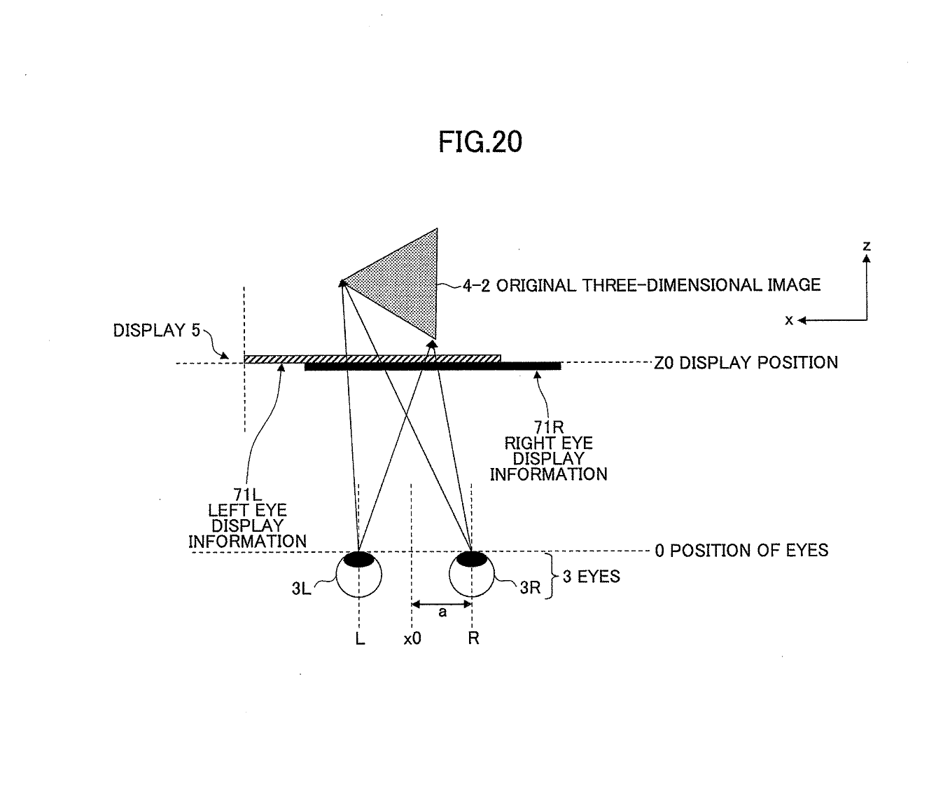

The method of FIG. 19 is described with reference to FIGS. 20 and 21. In FIGS. 20 and 21, elements corresponding to those in FIGS. 1 and 3 are denoted by the same reference numerals and are not further described.

FIG. 20 describes an example of a regular display of a three-dimensional image. In FIG. 20, the right eye display information 71R and the left eye display information 71L of the three-dimensional display information 70 are displaced from each other and displayed on the display 5. Accordingly, an original three-dimensional image 4-2 that has undergone a perspective process is displayed at the display position Z0.

In a regular display, the magnification ratio of the original three-dimensional image 4-2 is one, the right eye display information 4-2R and the left eye display information 4-2L are not generated, and the right eye display information 71R and the left eye display information 71L are displayed without modification. The user wears dedicated spectacles to view the original three-dimensional image 4-2.

FIG. 21 displays a display example of a three-dimensional image with depth. In FIG. 21, a three-dimensional image is reproduced by acquiring perspective information included in the three-dimensional display information 70, and a three-dimensional image 6-2 having distance that is formed by enlarging the reproduced three-dimensional image is displayed at the virtual image position Z1.

As the user views the three-dimensional image 6-2 having distance by wearing dedicated spectacles, the focal point of the user is at the virtual image position Z1 that is farther away than the display position Z0. Accordingly, the focal length is increased and eye fatigue is mitigated.

Next, a description is given of a display example in which a two-dimensional real image and a three-dimensional image are mixed.

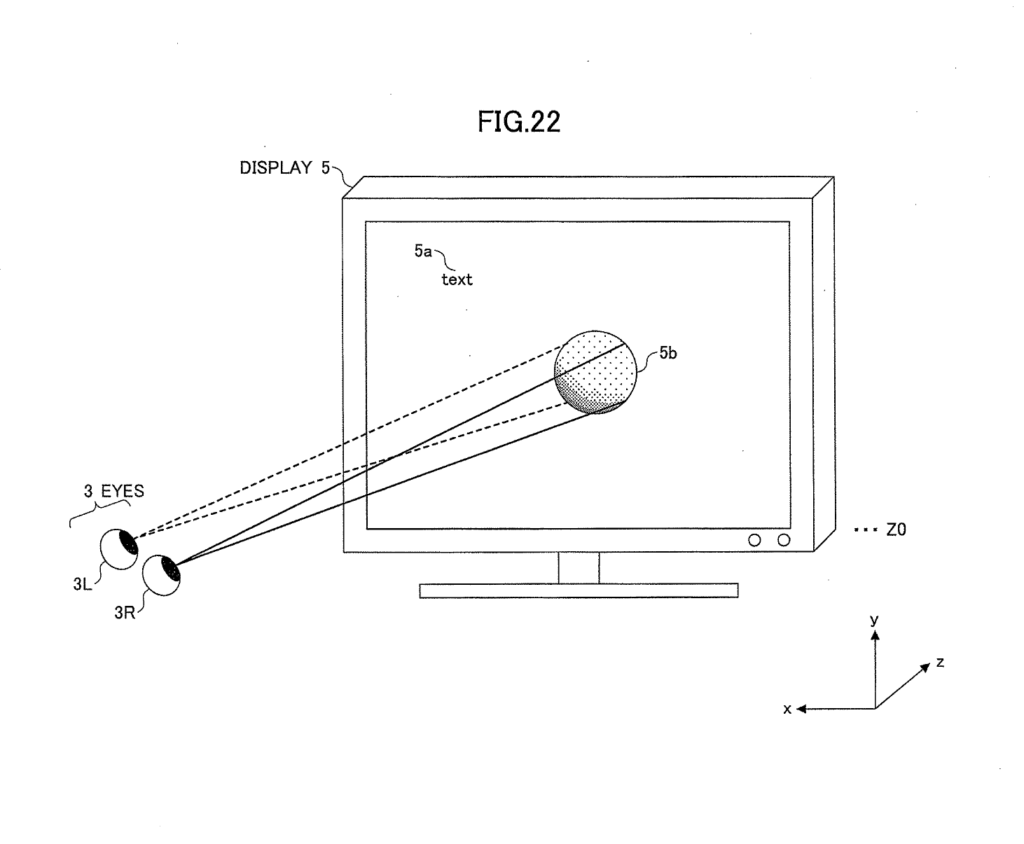

FIG. 22 illustrates a regular display example in which a two-dimensional real image and a three-dimensional image are mixed. In a regular display illustrated in FIG. 22, a two-dimensional real image 5a of “text” and a three-dimensional image 5b are displayed at a display position Z0 in the display 5. The user wears dedicated spectacles to view a display screen image in which the two-dimensional real image 5a and the three-dimensional image 5b are mixed. The user's focal length does not change whether the user is viewing the two-dimensional real image 5a or the three-dimensional image 5b.

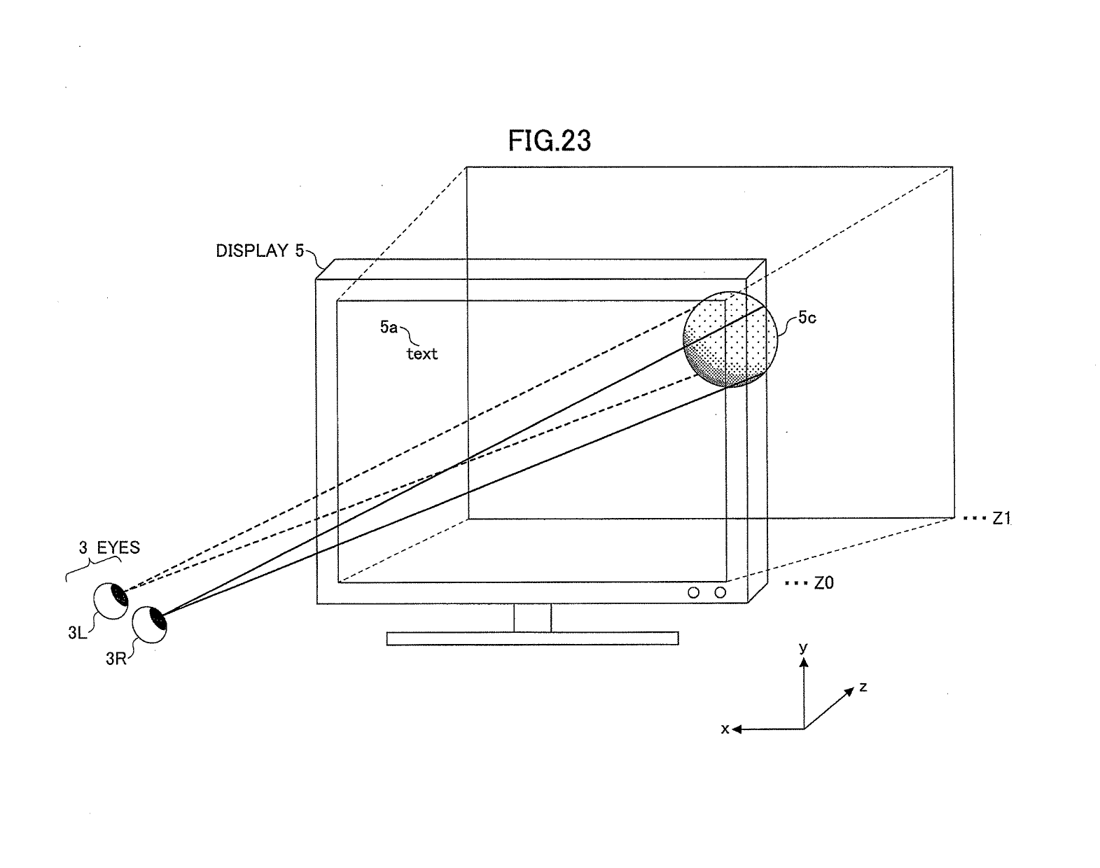

FIG. 23 illustrates a display example where depth is applied to the three-dimensional image of FIG. 22. In the display example of FIG. 23, by applying depth only to the three-dimensional image, the two-dimensional real image 5a of “text” is displayed at the display position Z0, and a three-dimensional image 5c that is formed by enlarging and applying depth (distance) to the three-dimensional image 5b is displayed at the virtual image position Z1.

When the user views the three-dimensional image 5c with distance by wearing dedicated spectacles, the user's focal point is at the virtual image position Z1 that is farther away than the display position Z0. When the user views the two-dimensional real image 5a by wearing dedicated spectacles, the user's focal point is at the display position Z0 that is closer than the virtual image position Z1. Accordingly, the focal length is changed every time the viewed object changes.

FIG. 23 illustrates a case where the three-dimensional image 5b is enlarged and has depth in a direction toward a farther position. However, the three-dimensional image 5b may be reduced and may have depth in a direction toward a closer position. Furthermore, the three-dimensional image 5b is the target of processing in FIG. 23; however, the two-dimensional real image 5a may be the target of processing, so that the two-dimensional real image 5a is reduced or enlarged and displayed at a virtual image position Z1 that is closer than or farther away than the display position Z0.

As described above, it is possible select the object to which the present embodiment is to be applied, in accordance with properties of the display information such as the number of dimensions.

The present embodiment is applicable to a computer device having a two-dimensional display function, such as a personal computer, a PDA (Personal Digital Assistant), a mobile phone, a video device, and an electronic book. Furthermore, the user's focal point is at a far away position, and therefore it is possible to configure a device for recovering or correcting eyesight.

Thus, according to the feature of the present embodiment of displaying information at a focal length at which eye fatigue is mitigated, it is easier to perform information processing operations and to view two-dimensional images and three-dimensional images, for users with shortsightedness, longsightedness, and presbyopia.

The displayed images according to the present embodiment cause the user's focal length to change, and therefore the physical location of the display 5 does not need to be changed to a position desired by the user. Thus, the present location of the display 5 is applicable. Furthermore, an image having distance that is enlarged or reduced with respect to the original image is displayed, and therefore there is no need to purchase a larger or smaller display 5.

Furthermore, applications may be used in the same manner as regular displays, without affecting applications that are typically used by the user.

It is possible to prevent the user's focal length from being fixed by changing the length to an image having distance (virtual image position Z1) according to user selection, and by displaying display information items by multiple layers (frames) positioned at different lengths. Furthermore, there may be a mechanism of changing the virtual image position Z1 by time periods. Furthermore, by allowing the user to select the magnification ratio m, an image size that is easy to view by a user with bad eyesight may be selected.

According to an aspect of the present invention, images are displayed so that the focal length of the user is varied, and therefore eye fatigue is mitigated or eyesight is recovered.

The present invention is not limited to the specific embodiments described herein, and variations and modifications may be made without departing from the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information display device comprising:
a storage area configured to store a display information item for displaying a real image on a display device;
a focal length setting unit configured to set a second focal length that is different from a first focal length extending from a user to the real image displayed on the display device;
a converting unit configured to convert the display information item stored in the storage area into a converted display information item for displaying a virtual image at the second focal length; and
a virtual image displaying unit configured to display the virtual image at the second focal length based on the converted display information item.

2. The information display device according to claim 1, wherein
the converting unit uses the display information item to generate right eye display information and left eye display information based on a convergence angle formed when a focal point of the user is at the virtual image, and stores the right eye display information and the left eye display information in the storage area, and
the virtual image displaying unit displays, on the display device, the right eye display information and the left eye display information stored in the storage area.

3. The information display device according to claim 1, wherein
the storage area stores a plurality of the display information items,
the information display device further comprises a grouping unit configured to group the plurality of the display information items into groups, and
the virtual image displaying unit displays, on the display device, a plurality of the virtual images corresponding to the respective groups, at different focal lengths.

4. The information display device according to claim 1, further comprising:
a rotating unit configured to three-dimensionally rotate the converted display information item.

5. The information display device according to claim 1, wherein
the virtual image corresponds to a part of a display screen image of the display device or the entire display screen image of the display device.

6. The information display device according to claim 1, wherein
the second focal length is set separately from the first focal length and a magnification ratio of the virtual image.

7. The information display device according to claim 1, wherein
the virtual image is formed by enlarging or reducing the real image according to a magnification ratio.

8. The information display device according to claim 1, wherein
the real image is a two-dimensional image or a three-dimensional image, and
the virtual image is a three-dimensional image.

9. An eyesight recovery device comprising:
a storage area configured to store a display information item for displaying a real image on a display device;
a focal length setting unit configured to set a second focal length that is different from a first focal length extending from a user to the real image displayed on the display device;
a converting unit configured to convert the display information item stored in the storage area into a converted display information item for displaying a virtual image at the second focal length; and
a virtual image displaying unit configured to display the virtual image at the second focal length based on the converted display information item.

10. An information display method executed by a computer device, the information display method comprising:
setting a second focal length that is different from a first focal length extending from a user to a real image displayed on a display device;
converting a display information item stored in a storage area for displaying the real image into a converted display information item for displaying a virtual image at the second focal length; and
displaying the virtual image at the second focal length based on the converted display information item.

11. A non-transitory computer-readable storage medium with an executable program stored therein, wherein the program instructs a processor of a computer device to execute the steps of:
setting a second focal length that is different from a first focal length extending from a user to a real image displayed on a display device;
converting a display information item stored in a storage area for displaying the real image into a converted display information item for displaying a virtual image at the second focal length; and
displaying the virtual image at the second focal length based on the converted display information item.
